(19) United States
(12) Patent Application Publication
(10) Pub. No.: US 2008/0140246 A1
(43) Pub. Date: Jun. 12, 2008

(54) SYSTEM FOR MANAGING PRODUCTION OF SEMICONDUCTORS

(75) Inventor: Kyung-Soo KANG, Gyeonggi-do (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-do (KR)

(21) Appl. No.: 11/936,575

(22) Filed: Nov. 7, 2007

(30) Foreign Application Priority Data
Dec. 6, 2006 (KR) 2006-00123121

(51) Int. Cl. G06F 19/00

(52) U.S. Cl. 700/109

(57) ABSTRACT

A system for managing production of semiconductors that can improve or maximize productivity. In an embodiment, the system comprises: a host computer for outputting control signals to control semiconductor production processes; semiconductor production apparatuses each of which performs a corresponding semiconductor production process using the control signals output from the host computer; a conveyor for conveying a wafer carrier; and a conveyor monitoring apparatus for monitoring the conveyance of the wafer carrier, determining if the conveyor is delayed for more than the predetermined time, and displaying an error status to a remote operator.

### CROSS-REFERENCE TO RELATED APPLICATION

This application claims the benefit of Korean Patent Application No. 10-2006-0123121, filed Dec. 6, 2006, the contents of which are hereby incorporated herein by reference in their entirety.

### BACKGROUND

1. Technical Field

The present invention relates to a system for managing production of semiconductors, and more particularly to a system for managing production of semiconductors, wherein the system includes a conveyor monitoring apparatus for monitoring whether a conveyor is operating normally.

2. Discussion of Related Art

In recent years, semiconductor production technology has developed toward improving the degree of integration, reliability, and processing speed as the information communication technology expands. Generally speaking, a semiconductor is produced by manufacturing a silicon wafer using silicon single crystals to be used as a substrate by forming various films on the semiconductor substrate, and by forming patterns having the electric and dielectric characteristics on the various films.

The patterns are formed by selectively or repeatedly performing unit processes such as a formation of a film, photolithography, polishing, and ion injection. In recent semiconductor production processes that require a design rule of less than 0.15 μm, the process conditions, such as pressure and temperature, applied to the unit processes should be precisely controlled. Various control units capable of such precision are actively being developed.

A production process line includes a plurality of semiconductor production apparatuses for mass production. There is a trend toward automation of the operations and controls of the semiconductor production apparatuses.

An example of automation is a transfer apparatus including an auto-guided vehicle (AGV) for transferring a semiconductor substrate in a bay area that includes the apparatuses for performing the production processes. In recent applications, transfer may be made by an overhead hoist transfer (OHT) as well as the AGV. The detailed structure of the OHT is disclosed in U.S. Pat. No. 6,092,678. The OHT is mainly applied to transferring an article including a wafer of 300 mm. The OHT is configured by installing a ceiling and a rail thereon in the bay area and for transferring an article using a vehicle traveling along the rail. A system for managing production of semiconductors using the OHT is disclosed in U.S. Pat. No. 7,024,275.

A conventional system for managing the production of semiconductors can sequentially move a wafer carrier, to which a plurality of wafers are mounted, between a plurality of semiconductor production apparatuses or stockers using the OHT. Then, the conveyor such as the OHT may be moved according to a program set in an unmanned bay area to convey the wafer carrier.

However, the conventional system for managing production of semiconductors has the following problem.

If the conveyor is stopped due to a defect or an error in control, the wafer carrier is delayed, causing a discontinuity in the semiconductor production processes. Productivity is then impaired.

Accordingly, the need remains for improved methods and systems for mitigating or eliminating these potential delays in order to maximize productivity.

### SUMMARY OF THE INVENTION

The present invention, among other embodiments, provides a system for managing production of semiconductors. The system is implemented so that it is capable of improving or maximizing productivity by preventing an inoperability of a semiconductor production apparatus due to a delay of a wafer carrier even when a conveyor is stopped due to its defect or an error in computation.

In accordance with one aspect, the present invention is directed to a system for managing production of semiconductors, comprising: a host computer configured to output first control signals to control semiconductor production processes; a plurality of semiconductor production apparatuses each configured to perform a corresponding semiconductor production process responsive to the first control signals; a conveyor to convey a wafer carrier between the plurality of semiconductor production apparatuses, the wafer carrier configured to hold a plurality of wafers; and a conveyor monitoring apparatus for monitoring the conveyance of the wafer carrier, for determining if the conveyor is delayed for more than a predetermined time, and for displaying a result of the determination.

In one embodiment, the conveyor monitoring apparatus comprises: a detection unit for detecting loading and unloading of the wafer carrier; a control unit for monitoring the conveyance of the wafer carrier and for determining if the conveyor is delayed for more than the predetermined time; and a display unit for displaying conditions of the plurality of semiconductor production apparatuses and whether the operation of the conveyor is normal or abnormal, using second control signals output from the control unit.

In accordance with another aspect, the present invention is directed to a method for managing semiconductor production, the method comprising outputting first control signals from a host computer configured to control semiconductor production processes and performing, responsive to the first control signals, a plurality of semiconductor production processes within a plurality of semiconductor production apparatuses. The process would then proceed where a plurality of wafers are conveyed within a wafer carrier between the plurality of semiconductor production apparatuses. Finally, the conveyance of the wafer carrier is monitored to determine if the conveyor is delayed for more than a predetermined time. If delayed an interlock control signal is output to suspend operations.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a diagram schematically showing a system for managing production of semiconductors according to an embodiment of the present invention;

FIG. 2 is a diagram showing a detection unit and a transmission unit for a pair of control terminals implemented within the system shown in FIG. 1; and

FIG. 3 is a diagram showing a receiving unit, a control unit, and a display unit implemented within the system shown in FIG. 1.

### DETAILED DESCRIPTION OF THE INVENTION

Hereinafter, a semiconductor production managing system according to preferred embodiments of the present invention will be described in detail with reference to the accompanying drawings. Although the preferred embodiments of the present invention will be described in detail, it can be understood that various changes and modifications can be made by those skilled in the art without departing from the spirit of the present invention, and that the changes and modifications are within the scope of the claims.

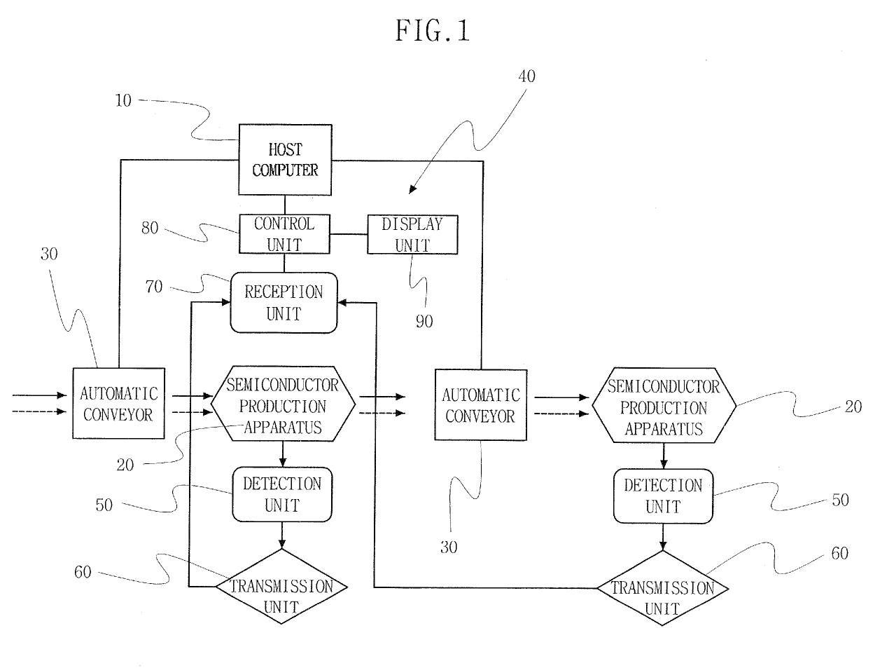

FIG. 1 is a diagram schematically showing a system for managing production of semiconductors according to an embodiment of the present invention.

As shown in FIG. 1, the system includes a host computer 10 for outputting control signals that generally control semiconductor production processes, a plurality of semiconductor production apparatuses 20, each of which performs a corresponding semiconductor production process using the control signals output from the host computer 10, a conveyor 30 for conveying a wafer carrier, to which a plurality of wafers are mounted, between the plurality of semiconductor production apparatus 20, and a conveyor monitoring apparatus 40 for monitoring the conveyance of the wafer carrier between the plurality of semiconductor production apparatuses 20 by the conveyor 30, and for determining and displaying the conveyor status regarding the conveyance of the wafer carrier. The conveyor monitoring apparatus 40 can determine if the wafer carrier is delayed for more than a predetermined time.

Here, the host computer 10 may be a general-purpose computer playing a key role in an data processing system. For example, the host computer 10 may play a key role in managing processing equipment and processing materials for the entire processing system. The host computer 10 may be a supercomputer, such as one having the proper name SiMAX. In the centralized system, a general-purpose (large-sized) computer system suitable for the processing capacity of the centralized system may be installed in a central computer room to centralize and control process requirements for processing data in all fields in a semiconductor production company.

In the system, the host computer preferably has a powerful operating system such as a time sharing system and a multi-programming system, as well as a communication control system to immediately process materials through a large number of terminals and in real-time. Further, since all the materials are centralized, the host computer 10 preferably includes an auxiliary memory of a high capacity. Therefore, all processing data, such as the process order of the semiconductor production apparatuses, a process environment, a process condition recipe, and distribution data on the wafer carrier, may be recorded in the auxiliary memory of the host computer 10 to allow all the semiconductor production apparatuses disposed in a semiconductor production line to execute the processes in an optimum state.

The semiconductor production apparatuses 20 sequentially perform the semiconductor production processes of the plurality of wafers mounted to the wafer carrier. The semiconductor production apparatuses 20 may include a chemical vapor deposition apparatus or a physical vapor deposition apparatus for forming thin films, such as interlayer insulation films, semiconductor films, and conductive metal films on the plurality of wafers. The semiconductor production apparatuses 20 may also include an ion injection apparatus for ion-injecting conductive impurities into the plurality of wafers or the semiconductor films, a photo spinner apparatus, an exposure apparatus, an etching apparatus, and a chemical mechanical polishing apparatus. Each of the apparatuses is well known in the art and will not be described in detail here.

Although not shown, the semiconductor production apparatuses 20 may include a plurality of user interfaces for receiving control signals that are output from the host computer 10. These control signals may control the semiconductor production apparatuses 20 to perform the semiconductor production processes according to a predetermined process order, the real-time process environment, and the process recipe determined by the host computer 10 or a user. For example, the user interfaces can receive data, which is required for the semiconductor production processes to be performed in the semiconductor production apparatus 20, from operators or managers working in the semiconductor production line. The user interfaces may communicate by a semiconductor equipment communications standard (SECS) protocol, which is a communication standard for the semiconductor production apparatuses 20, so they may share and exchange data. Further, the user interfaces and the host computer 10 may mutually transmit and receive data by communicating with each other using the transmission control protocol/Internet protocol (TCP/IP), which is a general communication standard.

The semiconductor production apparatuses 20 may be located in bay areas such as clean rooms to operate free from dust and moisture in the air and may be sequentially installed in the bay area according to the order of the semiconductor production processes. The bay areas may be divided into a manned bay area and an unmanned bay area. Further, since some production processes are occasionally repeated, it is often preferable to move the wafer carrier, to which wafers are mounted, to a predetermined position at a close range or at a long distance. For example, in a manned bay area, a manual conveyance vehicle (manual conveyor), to which the wafer carrier is mounted, can be carried by an operator. Further, in an unmanned bay area, an automatic conveyor 30 such as an automatic conveyance vehicle or an overhead hoist transfer can automatically carry the wafer carrier. Then, the semiconductor production apparatuses 20 may include a load port (not shown) in which the wafer carrier carried by the manual conveyance vehicle or the conveyor 30 is loaded. The load port is a preliminary place for loading the wafer carrier to which a plurality of wafers, to which the semiconductor production processes are to be performed, are mounted, and is a waiting place for unloading the wafer carrier to which the plurality of wafers whose semiconductor production processes have been finished. Further, the load port loads and unloads the wafer carrier conveyed by the conveyor 30 while extended beyond the semiconductor apparatuses 20. The semiconductor production processes of the plurality of wafers mounted to the wafer carrier are performed when the wafer carrier is introduced into the semiconductor production apparatuses 20.

The conveyor 30 may lift up the wafer carrier from a load port of the corresponding semiconductor production apparatus 20 and move the wafer carrier to a load port of a designated semiconductor production apparatus 20. Then, the conveyor 30 may load the wafer carrier on the load port of the designated semiconductor production apparatus 20. The conveyor 30 can move the wafer carrier to the designated semiconductor production apparatus 20 using the control signals output from the host computer 10. Although not shown, the conveyor 30 may include a conveyor control unit for receiving the control signals and for controlling the conveyor 30 in order to remove any equipment traffic congestion, avoid a collision, and to remove any unnecessary complexity in the unmanned bay area and to efficiently perform distribution. For example, if a conveyor track designation signal is output from the host computer 10 together with data of a wafer carrier, the conveyor control unit may determine the starting point and the destination of the wafer carrier. Further, the conveyor control unit may set the shortest movement path of the wafer carrier, determine whether the shortest movement path is distinguished from a movement path of another wafer carrier, and examine whether a bottle neck section is generated, in order to move the wafer carrier in a movement path capable of obtaining the maximum efficiency.

The operation of the conveyor 30 may be stopped in the unmanned bay area due to an unexpected accident such as a faulty operation of the semiconductor apparatus 20 or an inoperable control of the conveyor control unit. If a conveyor 30 is stopped in the unmanned bay area, it becomes difficult or impossible for an operator working in the manned bay area to recognize a potential accident. Thus, a large scale production delay may occur, which may become a large scale accident of the semiconductor production line.

Therefore, the system for managing semiconductor production according to the present embodiment may include a conveyor monitoring apparatus 40 for monitoring the conveyance, such as its position and speed, of the wafer carrier between the plurality of semiconductor production apparatuses 20 by the conveyor 30, and for determining and displaying whether the conveyor 30, which conveys the wafer carrier, is or is not delayed for more than a predetermined time in order to prevent a large scale accident of the semiconductor production line.

The conveyor monitoring apparatus 40 may include a detection unit 50 for detecting loading and unloading of the wafer carrier as it is conveyed by the conveyor 30 between the plurality of semiconductor production apparatuses 20, a transmission unit 60 for converting a detection signal that is output from the detection unit 50 to a radio signal and for transmitting the radio signal, a receiving unit 70 for receiving the radio signal and restoring the detection signal from the radio signal, a control unit 80 for determining how the wafer carrier is being conveyed by the conveyor 30 by using the detection signal restored in the receiving unit 70 and for determining if the conveyor is functioning properly without delay, and a display unit 90 for displaying operating conditions of the plurality of semiconductor production apparatuses 20 as well as operating conditions of the conveyor 30 by using control signals output from the control unit 80.

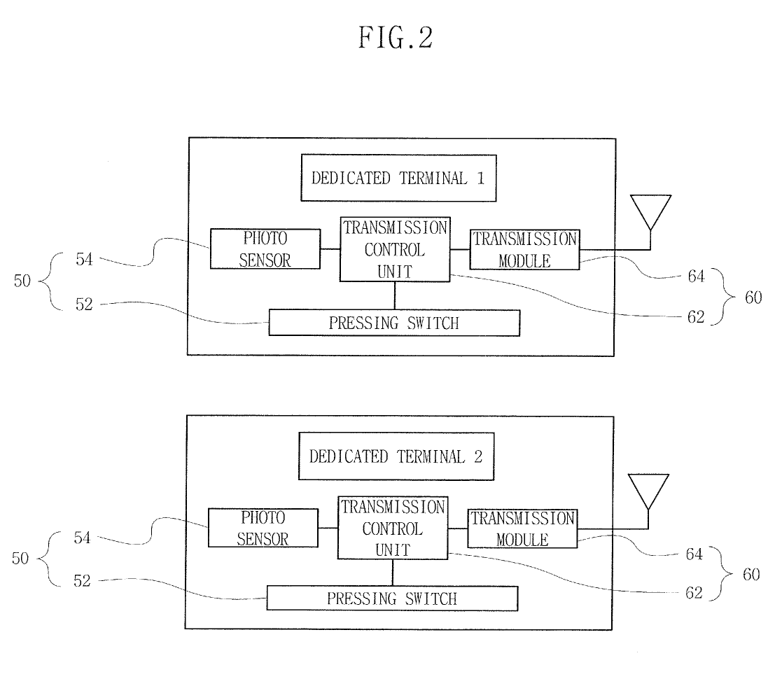

FIG. 2 is a diagram showing a detection unit 50 and a transmission unit 60 of the embodiment of FIG. 1. The detection unit 50 may include a plurality of sensors. The transmission unit 60 may include a transmission control unit 62 for integrating detection signals output from the detection unit 50 and a transmission module 64 for modulating the detection signals output from the transmission control unit 62, for carrying the modulated detection signals on carrier waves, and for outputting the detection signals wirelessly.

Here, the detection unit 50 may be configured to detect the condition of the wafer carrier as it is loaded in a load port of one of the semiconductor production apparatuses 20. For example, the detection unit 50 may include a contact sensor including a pressing switch 52 for detecting the condition of the wafer carrier by the load supported by the wafer carrier and a non-contact sensor that may include a photo sensor 54 for detecting the position of the wafer carrier by introducing incident light to the wafer carrier and receiving reflected light from the wafer carrier at positions that indicate the wafer carriers position. The conveyor monitoring apparatus 40 may include a plurality of detection units 50. The pressing switch 52 can be configured to output an electrical signal for detecting the wafer carrier's position as it is loaded in the load port by the conveyor 30, which can allow the control unit 80 to determine if the conveyor 30 successfully loads the wafer carrier in the load port. Further, the photo sensor 54 can detect that the wafer carrier that is loaded in the load port is inserted into the interior of a particular semiconductor production apparatus 20 and can allow the control unit 80 to monitor the semiconductor production process in the semiconductor production apparatus 20. The photo sensor 54 can output the detection signal of the wafer carrier onto a user interface.

If the wafer carrier to which a plurality of wafers whose semiconductor production process has been finished is not unloaded by the conveyor 30 in the corresponding semiconductor production apparatus 20 and is delayed in the load port for more than a preset period of time, the control unit 80 may output an interlock control signal to the conveyor 30 or the semiconductor production apparatus 20 and output a control signal to the display unit 90 to display the delay. For example, the control unit 80 may receive data on a run time required in the semiconductor production processes of the semiconductor production apparatuses 20 from the host computer 10 or the semiconductor production apparatuses 20.

Further, if the wafer carrier positioned in the load port is delayed for more than a predetermined period of time, compared to a corresponding run time for example, and is not then conveyed toward a subsequent semiconductor production apparatus 20 for performing the following process, then the control unit 80 may output an interlock control signal so that the conveyor 30 or the semiconductor production apparatus 20 can suspend operations. The display unit 90 may display any trouble that exists in the conveyor 30 or the semiconductor production apparatuses 20.

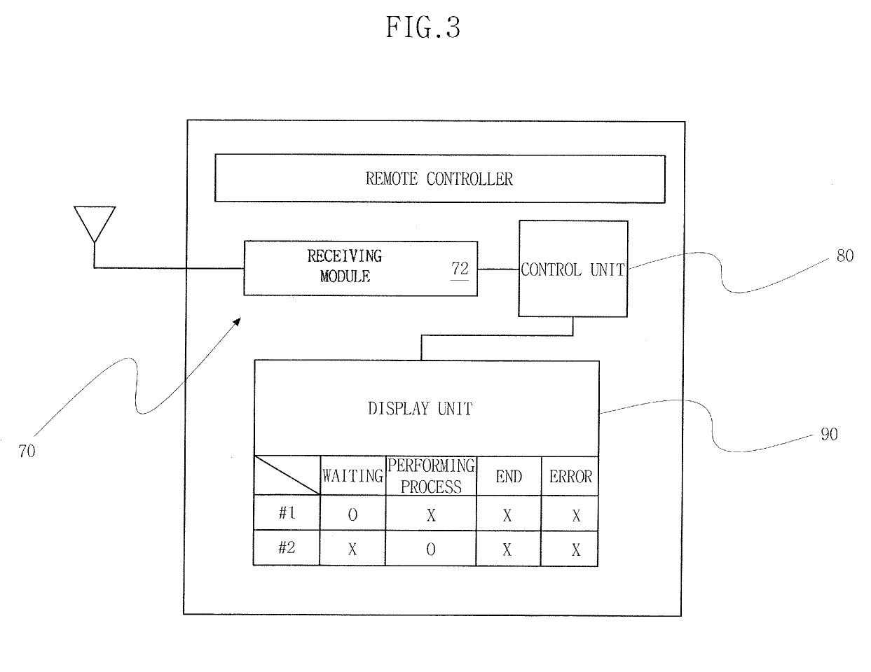

The display unit 90 can allow an operator working in the manned bay area to recognize the operating condition of the conveyor 30 as it moves (or does not move) the wafer carrier in the unmanned bay area or any of the semiconductor production apparatuses 20. For example, the display unit 90 may include a liquid crystal display unit, a 7-segment display, and an LED showing the operating condition of the conveyor 30, such as waiting for a process, performing a process, completing a process, and error generation. As shown in FIG. 3, conveyor #1 is in a waiting state while conveyor #2 is shown performing a process. No errors are indicated.

The transmission unit 60 and the receiving unit 70 may include a wireless network for performing short distance communication and long distance communication in the semiconductor production line including the unmanned and manned bay areas. The wireless network communication may allow the control unit 80 and the display unit 90 to recognize and display the operating conditions of the conveyor 30 and the semiconductor production apparatuses 20.

The transmission control unit 62 may be configured to wirelessly transfer the detection signals output from the detection unit 50 to the receiving unit 70 through the transmission module 64 every predetermined period of time. The transmission control unit 62 may utilize a standard communication system such as Bluetooth. The transmission module 64 may be configured to modulate the detection signals and to carry the detection signals on high frequency carrier waves to output the detection signals. For example, the transmission module 64 may include an RF modulator for carrying the detection signals on radio frequency carrier waves and for wirelessly outputting the detection signals. The transmission unit 60 may be connected to the receiving unit 70 by a communication network and may wirelessly output the data input in the detection unit 50 to the receiving unit 70.

The detection unit 50 and the transmission unit 60 may include dedicated terminals, such as dedicated terminal 1 and dedicated terminal 2 shown in the embodiment of FIG. 2, for detecting whether the wafer carrier is loaded by the conveyor 30 in the load port of the corresponding semiconductor production apparatus 20 and for monitoring the operating condition of the wafer carrier. For example, the dedicated terminals may be employed in each of the semiconductor production apparatuses 20, respectively.

FIG. 3 is a diagram showing the receiving unit 70, the control unit 80, and the display unit 90 of the embodiment of FIG. 1. The receiving unit 70 may include a receiving module 72 for receiving a wireless radio signal output from the transmission module 64 and for restoring the original detection signal. Here, the receiving module 72 may be adapted to separate modulated waves from the carrier waves transferred from the transmission module 64 and to restore the detection signal using the modulated waves. The demodulation method of the receiving module 72 may be determined by the modulation method. The demodulation method may be performed by a non-linear circuit such as a rectifier in the case of an amplitude modulation and is performed by combining a frequency discriminator and a demodulator in the amplitude modulation in the case of a frequency modulation or a phase modulation.

Further, the control unit 80 may be configured to determine the operating conditions of the conveyor 30 and the semiconductor production apparatuses 20 using the detection signal restored by the receiving unit 70. For example, the control unit 80 may be referred to as a receiving controller.

The display unit 90 allows an operator to easily recognize the operating conditions of the conveyor 30 and the semiconductor production apparatuses 20 using the control signals output from the control unit 80. Further, the display unit 90 may generate an alarm sound or turn on an alarm lamp when an error of the conveyor 30 or the semiconductor production apparatus 20 is generated.

Therefore, the receiving unit 70, the control unit 80, and the display unit 90 may include an integrally formed remote controller for allowing the dedicated terminals to restore the detection signals from the modulated waves carried and transferred on the carrier waves and to display the operating conditions of the conveyor 30 and the semiconductor production apparatuses 20. For example, the remote controller may be installed in the manned bay area to be managed by an operator to communicate with and control the transmission unit 60 remotely.

On the other hand, if the conveyor 30 loads the wafer carrier in the load port of any of the semiconductor production apparatuses 20, the detection unit 50 of the conveyor monitoring apparatus 40 may detect that the wafer carrier is loaded in the load port to output the detection signals to the transmission unit 60. Further, the transmission unit 60 may produce modulated waves by modulating the detection signals output from the detection unit 50 and carry the modulated waves on carrier waves to transfer the modulated waves to the receiving unit 70 wirelessly. The receiving unit 70 may be configured to restore the detection signals by separating the modulated waves from the carrier waves and to transfer the restored detection signals to the control unit 80. The control unit 80 may determine that the wafer carrier is loaded in the load port of any of the semiconductor production apparatuses 20 using the detection signals and output a control signal to display it on the display unit 90.

Further, if the corresponding semiconductor production process is completed in the semiconductor production apparatuses 20 and the wafer carrier is located in the load port, the control unit 80 may output a control signal to display the conveyance waiting state of the wafer carrier on the display unit 90.

Thereafter, if the conveyor cannot convey the wafer carrier for a predetermined period of time and the conveyance of the wafer carrier is delayed for more than a preset period of time in the conveyance waiting state, the control unit 80 may determine that a defect of the conveyor 30 itself or an error in computation is generated, and the display unit 90 would then display the erroneous state (e.g. where a ‘0’ is displayed in the “error” column of the display 90).

Therefore, the system for managing production of semiconductors according to the embodiments of the present invention can prevent an inoperability of the semiconductor production apparatuses 20 due to delays of the wafer carrier. The present system operates even when the overhead hoist transfer is stopped in the unmanned bay area due to a defect of the conveyor 30 itself or an error in computation. The conveyor monitoring apparatus 40 monitors the conveyance of the wafer carrier between the plurality of semiconductor production apparatuses 20 by the conveyor 30 and determines and displays the operating condition of the conveyor 30, thereby improving or maximizing the productivity.

The embodiments of the present invention are simply examples provided for a complete understanding of the present invention with reference to the drawings. One should not construe these embodiments to define the present invention. It should be understood that various changes and modifications can be made by those skilled in the art without departing from the spirit of the present invention.

What is claimed is:

1. A system for managing semiconductor production, the system comprising:
a host computer configured to output first control signals to control semiconductor production processes;
a plurality of semiconductor production apparatuses each configured to perform a corresponding semiconductor production process responsive to the first control signals;
a conveyor to convey a wafer carrier between the plurality of semiconductor production apparatuses, the wafer carrier configured to hold a plurality of wafers; and
a conveyor monitoring apparatus for monitoring the conveyance of the wafer carrier, for determining if the conveyor is delayed for more than a predetermined time, and for displaying a result of the determination.

2. The system according to claim 1, wherein the conveyor monitoring apparatus comprises:
a detection unit for detecting loading and unloading of the wafer carrier;
a control unit for monitoring the conveyance of the wafer carrier and for determining if the conveyor is delayed for more than the predetermined time; and
a display unit for displaying operating conditions of the plurality of semiconductor production apparatuses and the conveyor by using second control signals output from the control unit.

3. The system according to claim 2, wherein the detection unit comprises a contact sensor including a pressing switch for detecting the wafer carrier and a non-contact sensor including a photo sensor for detecting the wafer carrier.

4. The system according to claim 2, wherein the control unit is configured to receive data on a required run time for the semiconductor production processes from the host computer or the semiconductor apparatus and to output the second control signals for displaying whether the operation of the conveyor is normal or abnormal, wherein the abnormal operation includes the wafer carrier being delayed for more than the predetermined time so that the wafer carrier is not conveyed toward one of the semiconductor production apparatuses that is to perform a following process.

5. The system according to claim 2, wherein the display unit comprises a liquid crystal display unit, a 7-segment display, and an LED.

6. The system according to claim 2, wherein the conveyor monitoring apparatus further comprises a wireless network for transferring detection signals detected by the detection unit to the control unit by wireless communication.

7. The system according to claim 6, wherein the wireless network comprises a transmission unit for transmitting the detection signals detected in the detection unit wirelessly and a receiving unit for receiving the detection signals transmitted wirelessly from the transmission unit.

8. The system according to claim 7, wherein the transmission unit comprises a transmission controller for receiving the detection signals output from the detection unit every predetermined period, and a transmission module for modulating the detection signals output from the transmission controller, carrying the modulated detection signals on carrier waves, and outputting the detection signals wirelessly.

9. The system according to claim 8, wherein the transmission controller employs a Bluetooth communication method.

10. The system according to claim 8, wherein the transmission module comprises an RF modulator for carrying the detection signals on the carrier waves having radio frequencies and outputting the detection signals wirelessly.

11. The system according to claim 8, wherein the detection unit and the transmission unit comprise dedicated terminals for detecting whether the wafer carrier is loaded on a load port of the corresponding semiconductor production apparatus by the conveyor and for monitoring whether the wafer carrier is unloaded from the load port, respectively.

12. The system according to claim 7, wherein the receiving unit comprises a receiving module for receiving the wireless signals wirelessly that are output from the transmission module and for restoring the detection signal.

13. The system according to claim 7, wherein the receiving unit, the control unit, and the display unit comprise an integrally formed remote controller.

14. A method for managing semiconductor production, the method comprising:
outputting first control signals from a host computer configured to control semiconductor production processes;
performing, responsive to the first control signals, a plurality of semiconductor production processes within a plurality of semiconductor production apparatuses;
conveying a plurality of wafers within a wafer carrier between the plurality of semiconductor production apparatuses; and
monitoring the conveyance of the wafer carrier, determining if the conveyor is delayed for more than a predetermined time, and outputting an interlock control signal operative to suspend operations.

15. The method according to claim 14, wherein the step of monitoring the conveyance of the wafer carrier comprises:
detecting loading and unloading of the wafer carrier;
monitoring within a control unit the conveyance of the wafer carrier to determine if the conveyor is delayed for more than the predetermined time; and
displaying operating conditions of the plurality of semiconductor production apparatuses and the conveyor by using second control signals output from the control unit.

16. The method according to claim 15, wherein the step of detecting includes using a contact sensor and a non-contact sensor to detect loading and unloading of the wafer carrier.

17. The method according to claim 15, further including:
receiving data on a required run time for the semiconductor production processes from the host computer or the semiconductor apparatus; and
outputting the second control signals for displaying whether the operation of the conveyor is normal or abnormal, wherein the abnormal operation includes the wafer carrier being delayed for more than the predetermined time so that the wafer carrier is not conveyed toward one of the semiconductor production apparatuses that is to perform a following process.

18. The method according to claim 15, further including transferring detection signals to the control unit by wireless communication.

19. The method according to claim 18, further including:
receiving detection signals every predetermined period;
modulating the detection signals;
carrying the modulated detection signals on carrier waves; and
outputting the detection signals wirelessly.

20. The method according to claim 18, wherein the step of outputting the detection signals is done using either a Bluetooth communication method or using an RF modulator for carrying the detection signals on the carrier waves having radio frequencies and outputting the detection signals wirelessly.
